(19) United States
(12) Patent Application Publication
(10) Pub. No.: US 2011/0135322 A1
(43) Pub. Date: Jun. 9, 2011

(54) IMAGE FORMING APPARATUS, CONTROL METHOD THEREOF, AND STORAGE MEDIUM

(75) Inventor: Yuka Masuyama, Tokyo (JP)

(73) Assignee: CANON KABUSHIKI KAISHA, Tokyo (JP)

(21) Appl. No.: 12/954,162

(22) Filed: Nov. 24, 2010

(30) Foreign Application Priority Data
Dec. 7, 2009 (JP) 2009-278010

(51) Int. Cl. G03G 15/00

(52) U.S. Cl. 399/16; 399/81; 399/23

(57) ABSTRACT

An image forming apparatus including a plurality of paper feed stages includes a setting unit configured to set a paper type including a plurality of items for each of the plurality of paper feed stages, a storage unit configured to store a paper type history indicating a history of one or more paper types set by the setting unit for each paper feed stage, a control unit configured to acquire the stored paper type history for each paper feed stage, and a display control unit configured to display the acquired paper type history for each paper feed stage in a setting screen for setting the paper type for one of the plurality of paper feed stages to be able to be selected. The setting unit sets, for the paper feed stage, the paper type selected via the setting screen.

### BACKGROUND OF THE INVENTION

1. Field of the Invention

The present invention relates to an image forming apparatus that includes a plurality of paper feed stages and needs a paper type setting for each paper feed stage, a control method thereof, and a storage medium.

2. Description of the Related Art

In markets, clients have been increasingly demanding print on demand (POD) for the purpose of printing direct mails (DM) and invoices. Among the POD, particularly when invoices are printed, since printings need to be output in a large quantity, for each client, and in a predetermined period, continuous printing with a high productivity is required. Further, since some printings use a plurality of paper types in one job, an operator needs to efficiently set paper types not to reduce the productivity of the continuous printing.

However, in some configurations of printing apparatuses, when the number of paper feed stages that can be used is less than the number of paper types to be used for printing, the paper feed stages need to be frequently switched. In such a case, since the operator needs to frequently switch paper feed stages, a time for switching the paper feed stages once greatly affects the productivity of entire printing.

Currently, due to the paper setting having a layer structure, when the paper type setting for the paper feed stage is performed, a printing side, a paper size, and a paper type need to be selected every time the paper type setting is performed. Further, when a custom paper type is used, since it takes time to select the paper type from a list of the set custom paper types, experience values are also necessary.

A paper type simple setting is discussed for improving complication of the aforementioned paper type setting to enhance operability thereof (e.g., Japanese Patent Application Laid-Open No. 2007-243313). In a simple setting screen, a predetermined number of paper types are displayed, and the paper type can be selected therefrom. Further, when the paper type is selected, in order to improve convenience and operation efficiency, conditions of the paper type that can be selected are narrowed down based on a function setting of a print job, and the paper types are displayed in a list on an operation unit.

However, since only a predetermined number of paper types can be set on a conventional simple setting screen, when the different paper types are frequently switched, the paper type that has been previously set needs to be re-registered in the simple setting screen, thereby causing much work for the user.

### SUMMARY OF THE INVENTION

According to an aspect of the present invention, an image forming apparatus including a plurality of paper feed stages includes a setting unit configured to set a paper type including a plurality of items for each of the plurality of paper feed stages, a storage unit configured to store a paper type history indicating a history of one or more paper types set by the setting unit for each paper feed stage, an acquisition unit configured to acquire the paper type history for each paper feed stage stored by the storage unit, and a display control unit configured to display the paper type history for each paper feed stage acquired by the acquisition unit in a setting screen on a display unit for setting the paper type for one of the plurality of paper feed stages to be able to be selected. The setting unit sets, for the one paper feed stage, the paper type selected from the paper type history for each paper feed stage via the setting screen displayed by the display control unit.

According to an exemplary embodiment of the present invention, a user can reduce his or her work for setting a paper type. As a result, productivity of entire printing can be improved.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a system configuration of an image forming system according to a first exemplary embodiment of the present invention.

FIG. 2 is a block diagram of an image forming apparatus according to the first exemplary embodiment.

FIG. 3 is a plan view schematically illustrating a configuration of an operation unit illustrated in FIG. 2.

FIG. 4 illustrates an example of an initial screen displayed on a touch panel unit illustrated in FIG. 3.

FIG. 5 is a flowchart of paper setting processing using a paper type history according to the first exemplary embodiment.

FIG. 6 is a flowchart illustrating details of display processing in a setting screen according to the first exemplary embodiment.

FIG. 7 illustrates an example of a common specification setting screen according to the first exemplary embodiment.

FIG. 8 illustrates an example of a paper feed stage selection screen according to the first exemplary embodiment.

FIG. 9 illustrates an example of a history setting screen according to the first exemplary embodiment.

FIG. 10 illustrates an example of paper type history information stored by a paper feed stage setting history storage unit according to the first exemplary embodiment.

FIG. 11, composed of FIGS. 11A and 11B, is a flowchart illustrating processing for setting a paper type for a paper feed stage having an error according to the first exemplary embodiment.

FIG. 12 is a flowchart illustrating processing for setting for a paper feed stage a paper type specified for a next page of a print job according to the first exemplary embodiment.

FIG. 13 illustrates an example of a paper feed stage selection screen according to a second exemplary embodiment of the present invention.

FIG. 14A illustrates an example of a history setting screen displayed when a no-paper error occurs in a paper feed stage according to the second exemplary embodiment.

FIG. 14B illustrates an example of a history setting screen displayed when an error of paper that is not yet set registered occurs.

FIG. 15 is a flowchart illustrating processing for setting a paper type using a job history according to a third exemplary embodiment of the present invention.

FIG. 16 illustrates an example of a paper feed stage selection screen according to the third exemplary embodiment.

FIG. 17A illustrates an example of a history setting screen displayed when a target paper feed stage is selected.

FIG. 17B illustrates an example of a history setting screen displayed when a target paper feed stage is not selected.

FIG. 18 illustrates an example of a remote user interface (UI) for displaying a paper feed stage history according to the third exemplary embodiment of the present invention.

### DESCRIPTION OF THE EMBODIMENTS

Various exemplary embodiments, features, and aspects of the invention will be described in detail below with reference to the drawings.

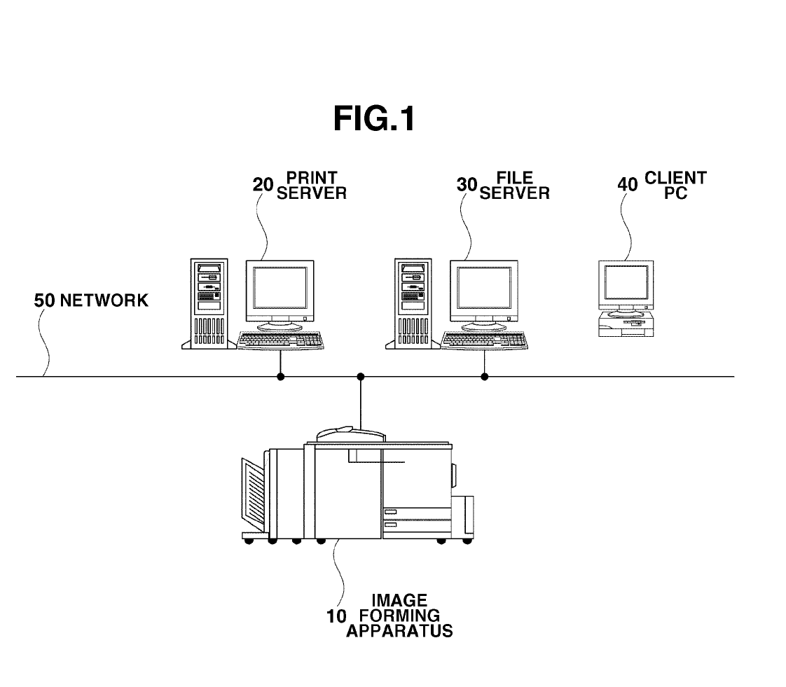

FIG. 1 is a block diagram illustrating an example of a basic configuration of an image forming system according to a first exemplary embodiment of the present invention. The image forming system according to the present exemplary embodiment includes an image forming apparatus 10, a print server 20, a file server 30, and a client personal computer (PC) 40. The image forming apparatus 10, the print server 20, the file server 30, and the client PC 40 are connected for communication with each other via a network 50 such as a local area network (LAN) and a wide area network (WAN).

The image forming apparatus 10 includes various types of functions, such as scan, print, and copy. The print server 20 manages a print job for causing the image forming apparatus 10 to perform printing. The print server 20 can monitor statuses of all print jobs performed by the image forming apparatus 10 and can also perform pause, setting change, print resumption, copy, movement, and deletion on each print job.

The file server 30 stores a database of variable data used for variable printing, which is, for example, client database including client data such as destinations, addresses, and names. The client PC 40 includes functions for performing edition of application files and supporting printing. Additionally, the client PC 40 includes a function for assisting to monitor and control the print job performed by the image forming apparatus 10 managed in the print server 20. An operator can check the status of the print job using the client PC 40.

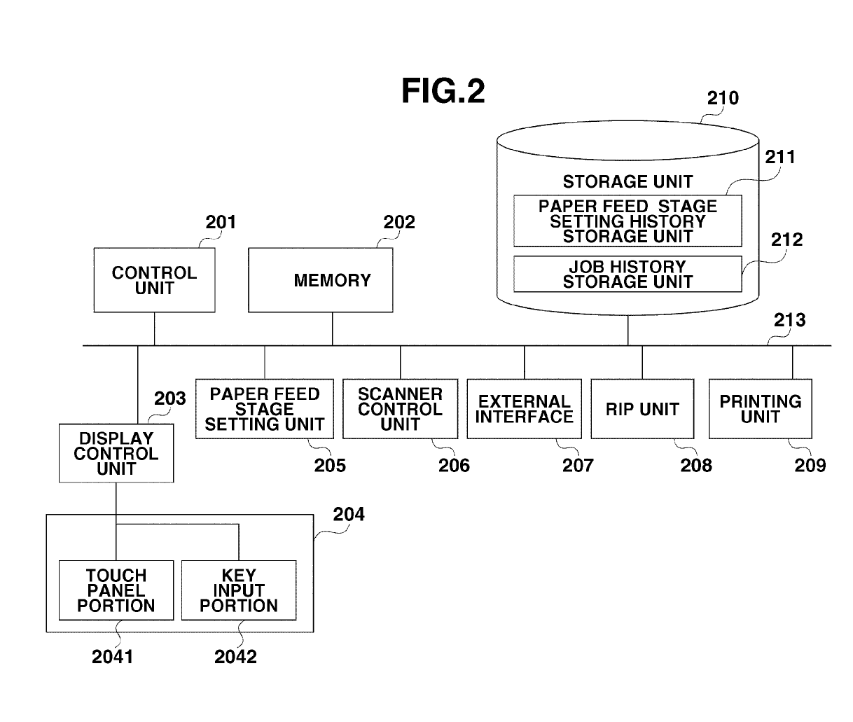

Next, with reference to FIG. 2, a configuration of the image forming apparatus 10 will be described. FIG. 2 is a block diagram illustrating a basic configuration of the image forming apparatus 10.

A control unit 201 controls each configuration connected therewith via a system bus 213 and entire operations performed by the image forming apparatus 10. The control unit 201 executes programs stored in a memory 202 to control each configuration included in the image forming apparatus 10. Further, the control unit 201 includes a random access memory (RAM) for temporarily storing data necessary for control and a central processing unit (CPU) for executing the data temporarily stored in the RAM.

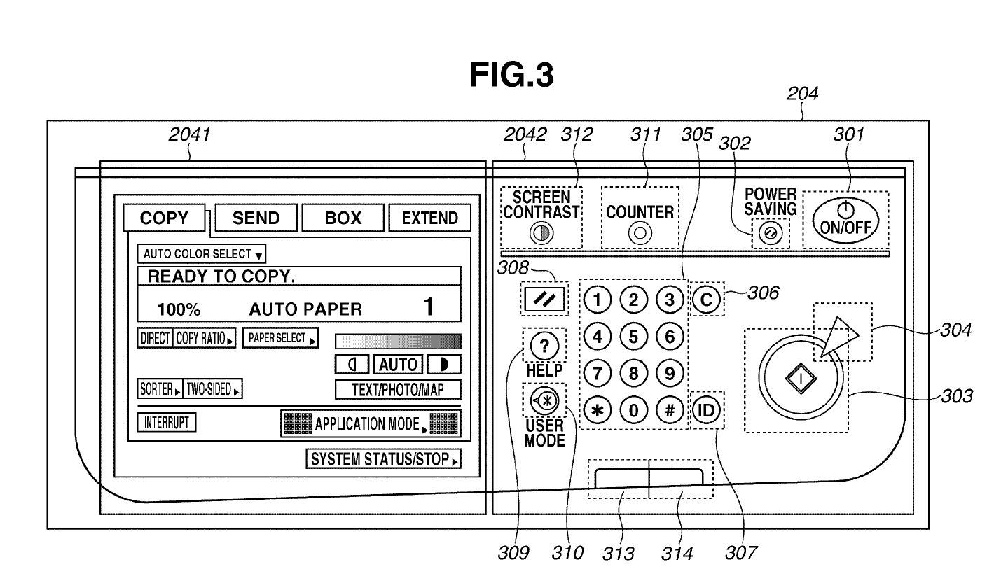

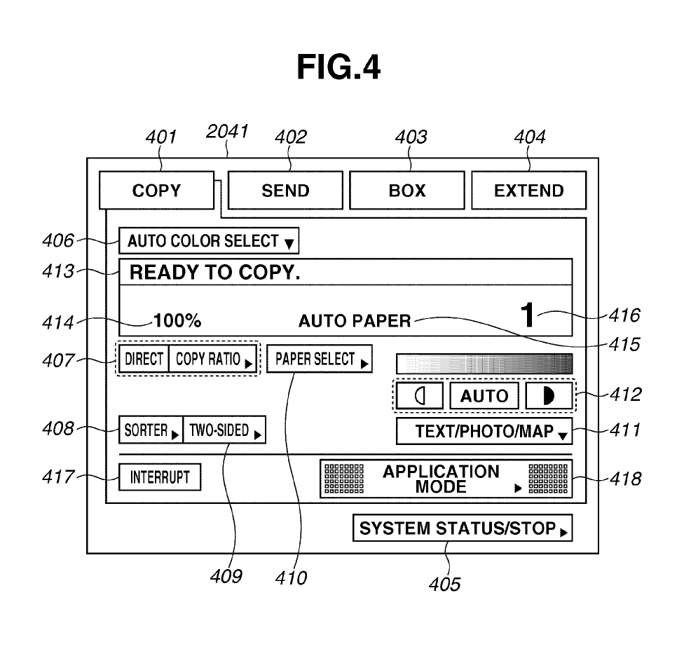

An operation unit 204, where the operator performs various types of inputs, includes a touch panel portion 2041 and a key input portion 2042. The operation unit 204 can perform the paper type setting for the paper feed stage. Details of the operation unit 204 will be described below with reference to FIGS. 3 and 4.

The display control unit 203 functions as an interface between the control unit 201 and each of the touch panel portion 2041 and the key input portion 2042 included in the operation unit 204. The display control unit 203 transfers information input from the touch panel portion 2041 and the key input portion 2042, and further, transfers display information to be displayed on the touch panel portion 2041.

A storage unit 210 includes non-volatile memories such as a hard disk, and stores image data generated by each processing, and control information and setting information about the image forming apparatus 10. Additionally, the storage unit 210 includes a paper feed stage setting history storage unit 211 and a job history storage unit 212.

The paper feed stage setting history storage unit 211 stores paper type information for each paper feed stage used by executed jobs. Further, the job history storage unit 212 stores job history information for each executed job. Furthermore, when data is read/written from/into the storage unit 210, the data is read/written via the memory 202.

The scanner control unit 206 controls scanning processing based on instructions from the control unit 201. A paper feed stage setting unit 205 controls display information to be displayed on the touch panel portion 2041 based on information stored in the paper feed stage setting history storage unit 211 or information stored in the job history storage unit 212, and gives instructions to the display control unit 203. An external interface 207 sends/receives information to/from an external apparatus via a network or public lines.

A raster image processor (RIP) unit 208 performs RIP processing on image data according to the instruction from the control unit 201. A printing unit 209 performs printing processing on the image data on which the RIP processing has been performed by the RIP unit 208.

Next, with reference to FIGS. 3 and 4, a configuration of the operation unit 204 will be described. FIG. 3 is a plan view schematically illustrating a configuration of the operation unit 204. FIG. 4 illustrates an example of an initial screen displayed on the touch panel portion 2041.

First, with reference to FIG. 3, a configuration of, particularly, the key input portion 2042 of the operation unit 204 will be described. The key input portion 2042 is a key input portion via which the normal operation setting can be performed. A switch 301 switches a standby mode (normal operation state) and a sleep mode (a state where a main controller stops a program in an interruption state for preparing for network printing or facsimile to save power consumption).

This switch 301 can perform control when a main power switch for supplying power source to the entire system is turned on. A power saving key 302 drops a control temperature of a fixing device during a standby mode, to suppress power consumption. By setting a power saving ratio, the control temperature can be also dropped.

A start key 303 is a key for giving an instruction for beginning copy or sending. A stop key 304 is a key for stopping copy or sending. A numeric keypad 305 includes keys for registering numbers for each setting, and a clear key 306 is a key for canceling the registration of the numbers. An identification (ID) key 307 is a key for inputting a predetermined password to identify an operator of the image forming apparatus 10.

A reset key 308 is a key for nulling each setting and then returning the setting to a default state. A help key 309 is a key for displaying guidance or help, and a user mode key 310 is a key for causing processing to proceed to a common specification setting screen.

A counter check key 311 is a key for causing a soft counter that is provided in the image forming apparatus 10 and counts the number of prints to display the number of output prints stored therein. The number of output prints can be displayed according to operation modes (e.g., a copy mode, a print mode, a scan mode, and a fax mode), a color mode (e.g., a color mode and a monochromatic mode), and a paper size (e.g., large and small). An image contrast dial 312 is a dial for adjusting visibility of the screen by adjusting backlight of a liquid crystal display on the touch panel portion.

An execution/memory lamp 313 is a lamp that blinks to inform the user of a job execution or an access to a memory. An error lamp 314 is a lamp that blinks to inform the user of an error in which the job cannot be executed, a serviceman call is necessary, or an operator call in which a jam or a shortage of consumable goods occurs.

Next, with reference to FIG. 4, the touch panel portion 2041 will be described. The touch panel portion 2041 illustrated in FIG. 4 is a touch panel display including a liquid crystal display (LCD) and a transparent electrode attached thereon. When an operator's finger touches a part of the transparent electrode corresponding to a key displayed on the LCD, the touch panel portion 2041 detects the touch and controls a display of a screen according to the pre-set program, for example, another operation screen is displayed. FIG. 4 illustrates an initial screen in the standby mode. The touch panel portion 2041 displays various types of operation screens according to use's operations.

A copy tab 401 is a tab key for changing a screen to an operation screen for performing a copy operation. A sending tab 402 is a tab key for changing a screen to an operation screen for instructing a sending operation of fax or e-mail. A box tab 403 is a tab key for changing a screen to a screen for inputting and outputting a job to/from a box (storage unit for storing jobs for each user). An option tab key 404 is a tab key for setting an extension function such as scanner setting.

A system monitor key 405 is a key for displaying a status and a state of the image forming apparatus 10. By selecting each tab described above, a screen can be changed to each mode. A color selection setting key 406 is a key for previously selecting color copy, monochromatic copy, or auto selection. A copy ratio setting key 407 is a key for changing a screen to a screen for performing a copy ratio setting for direct, enlargement, or reduction.

A post processing setting key 408 is a key for changing a screen to a screen for setting the number of staples or punches, positions thereof, and no staples and no punches. A two-sided setting key 409 is a key for changing a screen to a screen for selecting one-sided printing or two-sided printing. A paper size setting key 410 is a key for changing a screen to a screen for selecting the paper feed stage, a paper size, and a medium type. An image mode setting key 411 is a key for selecting an image mode appropriate for a document image such as a text mode and a photo mode.

A density setting key 412 is a key for adjusting darkness or brightness of an output image. Next, a status display unit 413 displays statuses in a simple manner, such as a standby status, during worming up, a jam, and an error. A copy ratio display unit 414 displays a copy ratio set with a copy ratio setting key. A paper size display unit 415 displays a paper size and a mode set with the paper size setting key.

A number of copies display unit 416 displays the number of copies specified with the numeric keypad, and also displays what number of copies is being printed during the operation. Further, an interruption key 417 is used when another job is to be interposed during the copy operation. An application mode key 418 is a key for changing a screen to a screen for performing settings of various types of image processing and lay out including, for example, series copy, cover/inserted sheet setting, reduced layout, and image movement.

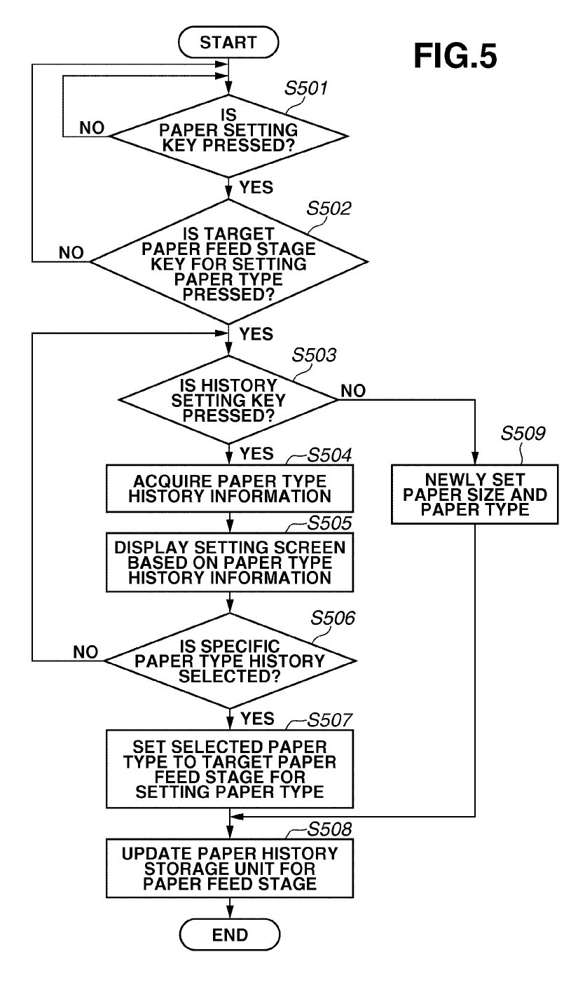

Next, with reference to FIG. 5, paper type setting processing using a paper type history will be described. FIG. 5 is a flowchart of processing for setting a paper type for the paper feed stage using the paper type history for each paper feed stage. Each processing illustrated by the flowchart in FIG. 5 is performed by the control unit 201, the display control unit 203, and the paper feed stage setting unit 205 when the control unit 201 executes the programs stored in the memory 202.

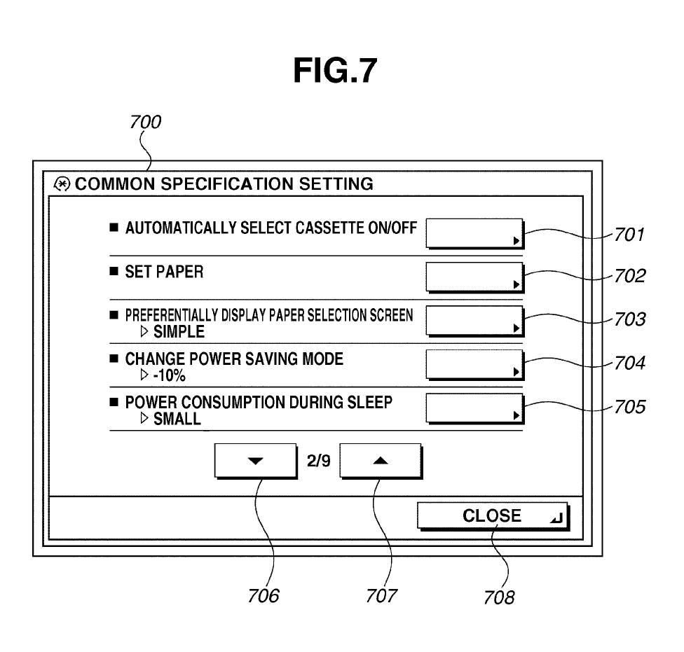

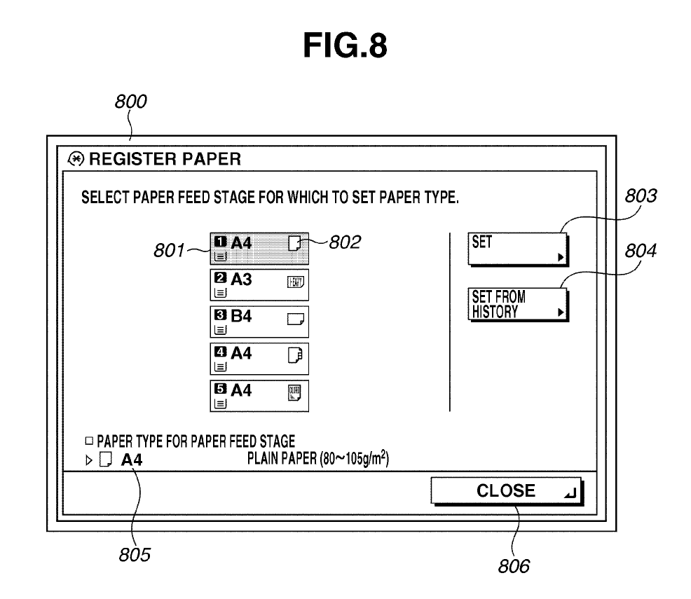

In step S501, the control unit 201 monitors whether the user presses the paper setting key 702 on the common specification setting screen that is displayed on the touch panel portion 2041 illustrated in FIG. 7. When the user presses the paper setting key 702, the display on the touch panel portion 2041 is changed to the paper feed stage selection screen illustrated in FIG. 8.

In step S502, the control unit 201 monitors whether the user presses a target paper feed stage key for setting a paper type in the paper feed stage selection screen. When the user presses one of a plurality of paper feed stage keys, the processing proceeds to step S503. Among a plurality of paper feed stages included in the image forming apparatus 10, the paper feed stage corresponding to the paper feed stage key (802 in FIG. 8) pressed in step S502 becomes a targeted paper feed stage (target paper feed stage) of the paper type setting.

In step S503, the control unit 201 monitors whether the user presses a history setting key 804. When the user presses the history setting key 804, the processing proceeds to step S504. On the other hand, when the user presses a setting key 803 not the history setting key 804, the processing proceeds to step S509.

In step S504, the print server 205 acquires the paper type history information for each paper feed stage from the paper feed stage setting history storage unit 211, and then transmits the acquired paper type history information to the display control unit 203. In step S505, based on the paper type history information transmitted from the paper feed stage setting unit 205 in step S504, the display control unit 203 displays on the touch panel portion 2041 the history setting screen in which the paper type history for each of a plurality of paper feed stages can be selected.

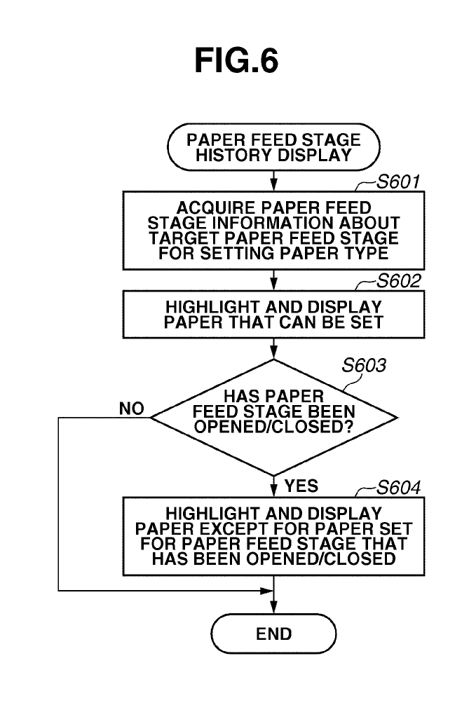

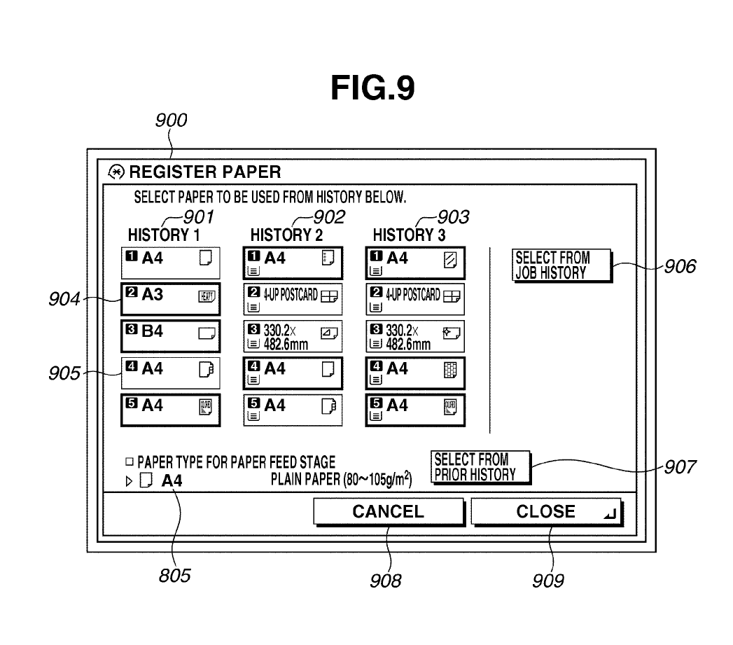

FIG. 9 illustrates an example of the displayed history setting screen. Details in step S505 will be described below with reference to FIG. 6. In the aforementioned history setting screen, in addition to the target paper feed stage for which the paper type is set, the paper type histories for respective other paper feed stages included in the image forming apparatus 10 are displayed to be able to be selected. With this display, in addition to from the paper type histories of the target paper feed stage for which the paper type is set, the paper type can be selected from the paper type histories of other paper feed stages.

In step S506, the control unit 201 waits for the user to select a specific paper type history from the paper type histories for the respective plurality of paper feed stages via the history setting screen displayed in step S505 and to give an instruction for setting the paper type. When the user selects the specific paper type history and gives the instruction for setting the paper type, the processing proceeds to step S507. On the other hand, when the user does not select the specific paper type history and presses a cancel key 908, the processing returns to step S503.

In step S507, the paper feed stage setting unit 205 sets the paper type selected in step S506 for the target paper feed stage determined in step S502. In step S508, the paper feed stage setting unit 205 updates the paper type history information stored in the paper feed stage setting history storage unit 211.

More specifically, the paper type set for the target paper feed stage in step S507 or step S509 is added to and written into the paper type history information about the paper feed stage for which the paper type is set. As described above, the paper type history information for each set paper feed stage is stored in the paper feed stage setting history storage unit 211 so that, when the paper type is set next, the setting can be performed based on the paper type history information this time.

In step S509, the paper feed stage setting unit 205 newly sets the paper type such as the paper size and the paper specification according to the user's operations for the target paper feed stage determined in step S502.

Next, with reference to the flowchart illustrated in FIG. 6, display processing on the history setting screen in step S505 illustrated in FIG. 5 will be described in detail. The control unit 201 executes the program stored in the memory 202, so that the control unit 201, the display control unit 203, and the paper feed stage setting unit 205 perform each processing described in the flowchart illustrated in FIG. 6.

In step S601, the control unit 201 acquires the paper feed stage information about the paper feed stage determined to be the paper feed stage for which the paper type is set in step S502 illustrated in FIG. 5, and then transmits the acquired paper feed stage information to the paper feed stage setting unit 205. The paper feed stage information for each paper feed stage is stored in the storage unit 210 as the setting information about the image forming apparatus 10. Further, the paper feed stage information includes information indicating what paper type of the paper information can be set.

In step S602, the paper feed stage setting unit 205 controls, based on the paper feed stage information about the target paper feed stage and the acquired paper type history information, the operation unit 204 to display the history setting screen in which the paper type histories of the paper types that can be set for the target paper feed stage are highlighted. This is because the paper type that cannot be set for the paper feed stage is prevented from being set, since some paper types cannot be fed to some paper feed stages.

According to the present exemplary embodiment, the paper type history of the paper type that has a higher priority and can be set for the target paper feed stage is highlighted. However, the method is not limited thereto. The history setting screen may be displayed in a state where the user can discriminate the paper type history of the paper type that can be set for the target paper feed stage from the paper type history of the paper type that cannot be set for the target paper feed stage. For example, the history setting screen may be displayed in a state where the paper type history of the paper type that has a low priority and cannot be set for the target paper feed stage is displayed in gray not to be able to be selected.

In step S603, the paper feed stage setting unit 205 determines whether a paper feed stage open/close event of the target paper feed stage is notified to the control unit 201 within a predetermined period. When it is determined that the paper feed stage open/close event is notified (YES in step S603), the processing proceeds to step S604. On the other hand, when it is determined that the paper feed stage open/close event is not notified (NO in step S603), the processing ends.

With this determination, it is determined whether the target paper feed stage is opened before the user sets the paper type, or during the setting. An arbitrary period may be set by the user as the predetermined period, which may be since a special event has occurred until the determination is performed. For example, a period since an error has occurred until a determination is performed or a period since the paper setting processing has started until a determination is performed may be set.

In step S604, the paper feed stage setting unit 205 controls the display control unit 203 to, of a plurality of paper type histories for the respective paper feed stages, highlight the paper type history of the paper type different from the paper type that is currently set for the target paper feed stage. When the target paper feed stage is opened before the user sets the paper type or during the setting, it is highly likely to change the setting to a paper type different from the currently set paper type.

Thus, with the processing described above, it has becomes possible to obviously display what is the setting except for the current paper type to be easily understood by the user. According to the present exemplary embodiment, the paper type history of the paper type different from the paper type that has a higher priority and is currently set for the target paper feed stage is highlighted. However the method is not limited thereto.

The history setting screen may be displayed in a state where the user can discriminate the paper type currently set for the target paper feed stage from the paper type history of the paper type different from the paper type currently set for the target paper feed stage. For example, the history setting screen may be displayed in a state where the paper type history of the paper type that has a low priority and is currently set for the target paper feed stage is displayed in gray and cannot be selected.

Next, with reference to FIGS. 7, 8, and 9, an example of a screen displayed on the touch panel portion 2041 when the user sets the paper type will be described.

FIG. 7 illustrates an example of a common specification setting screen displayed on the touch panel portion 2041 when the user mode key 310 illustrated in FIG. 3 is pressed. A common specification setting screen 700 displays items for setting common specifications for printing. When each of a cassette auto selection ON/OFF setting key 701, a paper setting key 702, a paper selection screen priority display setting key 703, a power saving mode change key 704, and a during-sleep power saving setting key 705 is pressed, the display control unit 203 displays a setting screen according to each key. Scroll keys 706 and 707 can be pressed so that the display control unit 203 displays other setting items. When scroll keys 706 and 707 are pressed, the display control unit 203 displays other setting items. When a closing key 708 is pressed, the display control unit 203 closes the common specification setting screen 700.

FIG. 8 illustrates, in the common specification setting screen 700 illustrated in FIG. 7, an example of a paper feed stage selection screen displayed on the touch panel portion 2041 when the paper setting key 702 is pressed. On a paper feed stage selection screen 800, the user selects the target paper feed stage for which the paper type is set.

A paper feed stage keys 801 are keys corresponding to respective paper feed stages for which the paper type can be set. When the paper feed stage key 801 is pressed, the paper feed stage corresponding to the pressed paper feed stage key becomes the target paper feed stage. According to the present exemplary embodiment, the image forming apparatus 10 includes five paper feed stages. Further, when the user presses the paper feed stage key, as illustrated with the paper feed stage key 802, the display thereof is switched so that the user can recognize the selected stage.

A setting key 803 is pressed to newly select a plurality of items including the paper size and the paper specification to set the paper type. This is a conventional method for setting the paper type. When a history setting key 804 is pressed, the display control unit 203 displays a history setting screen 900 illustrated in FIG. 9. If the paper has been used by the user before, when the history setting key 804 is pressed, the paper type can be set from the paper type histories while avoiding troublesome operations in which a plurality of items including the paper size and the paper specification are selected from enormous options.

A paper setting display portion 805 displays information about the paper type currently set for the target paper feed stage that is selected by the user from among the paper feed stage keys 801. When a closing key 806 is pressed, the display control unit 203 closes the paper feed stage selection screen 800 and displays the common specification setting screen 700.

FIG. 9 illustrates an example of a history setting screen displayed on the touch panel portion 2041 when the history setting key 804 is pressed in the paper feed stage selection screen 800 illustrated in FIG. 8. In a history setting screen 900, the user selects the paper type history corresponding to the paper type to be set for the target paper feed stage from the paper type histories for the respective plurality of paper feed stages in order to set the paper type according to the selection.

Paper feed stage history display portions 901, 902, and 903 display the paper type histories for respective paper feed stages. The user selects any one of the displayed paper type histories for respective paper feed stages so that the paper type matching the selected paper type history can be set as the target paper feed stage. In this screen, the user can select the paper type history of the paper type to be set for the target paper feed stage from among the paper type histories for the paper feed stages different from that of the target paper feed stage selected in the paper feed stage selection screen 800 for selecting the paper feed stage.

The history 1 (901) is the paper type history representing the paper type currently set for the paper feed stage. According to the present exemplary embodiment, the histories 1, 2, and 3 display three types of paper type histories for respective paper feed stages. However, the method is not limited thereto, and three or more paper type histories may be displayed.

A paper type history 904 illustrates an example of the paper type history that has a high priority and is highlighted. According to the present exemplary embodiment, the paper type history of the paper type that can be set for the target paper feed stage is highlighted. On the other hand, a paper type history 905 illustrates an example of the paper type history that has a low priority and is not highlighted.

According to the present exemplary embodiment, a paper type history of the paper type that cannot be set for the target paper feed stage is not highlighted. This display method is one example, and the paper type history of the paper type having a low priority may be displayed in gray not to be able to be selected.

A job history selection key 906 is pressed when the paper type to be set is selected not from the paper type history for each paper feed stage but from the paper type history for each print job. Selection from the job history will be described below in a third exemplary embodiment.

When a past history selection key 907 is pressed, a screen is switched to display the paper type history that has been set for each paper feed stage prior to the histories 1, 2, and 3. When a cancel key 908 is pressed, the setting is not stored. Then, the history setting screen 900 for the paper is closed, and the display returns to the copy screen illustrated in FIG. 4. When the user presses the cancel key 908, the selected paper type is set for the target paper feed stage, the history setting screen 900 for the paper is closed, and the display returns to the copy screen.

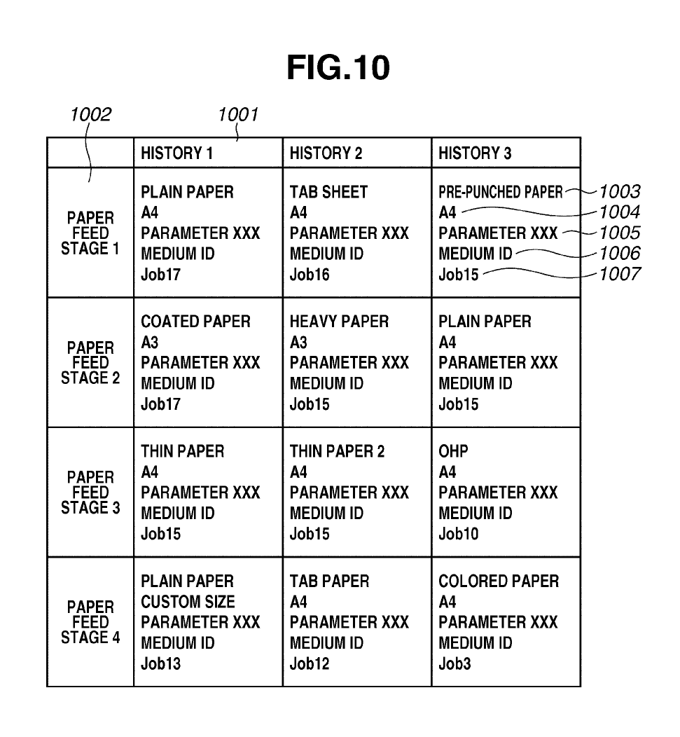

FIG. 10 illustrates an example of the paper type history information for each paper feed stage stored by the paper feed stage setting history storage unit 211. The paper type history information illustrated in FIG. 10 is stored by the paper feed stage setting history storage unit 211 in step S508 illustrated in FIG. 5.

Histories 1001 are stored for respective paper feed stages 1002. The paper type history is independently set for each paper feed stage. The history 1 for the paper feed stage 1 and the history 1 for the paper feed stage 2 may not be set in the image forming apparatus 10 at the same period. A plurality of items included in the stored paper type history information include, for example, a paper (medium) type 1003, a paper size 1004, various types of parameters of paper 1005, a medium ID 1006, and a used print job ID 1007.

As described above, as the paper type history information, the paper type is associated with a job history such as the ID of the job for which the paper type is used, and stored. The parameter 1005 includes parameters for defining the paper type, such as a grammage and surface nature of the paper. Further, the paper type history information is not limited to the example illustrated in FIG. 10, but other information may be stored.

As described above and as illustrated in the first exemplary embodiment, unlike the past, the user can set the paper from the paper type history for each paper feed stage, thereby reducing work for newly selecting and setting the paper size and the paper specification each time. In addition, when the paper type history for each paper feed stage is displayed, the paper that can be fed to the target paper feed stage is highlighted, thereby preventing a setting mistake in which the user sets the setting of the paper feed stage with which the paper cannot be fed.

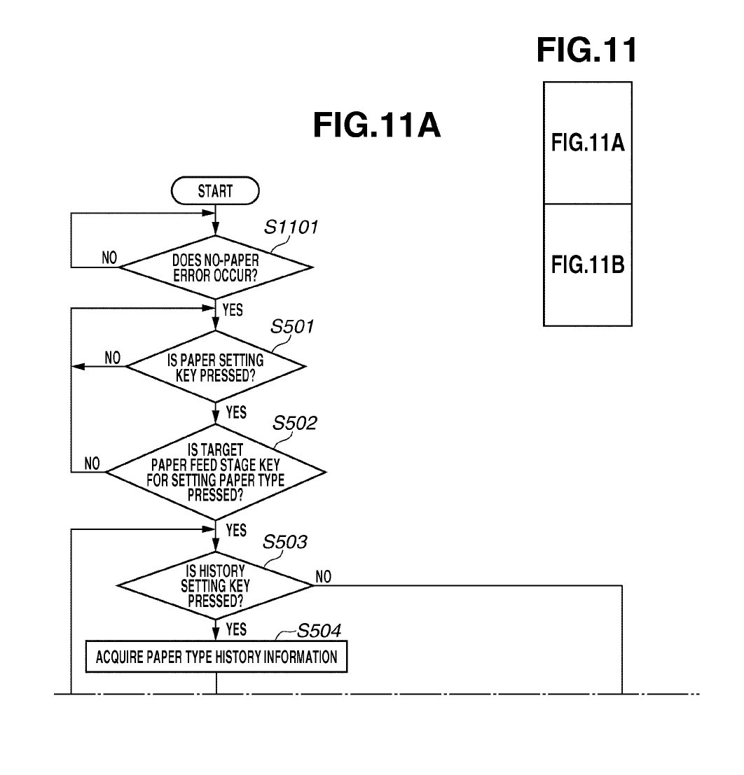

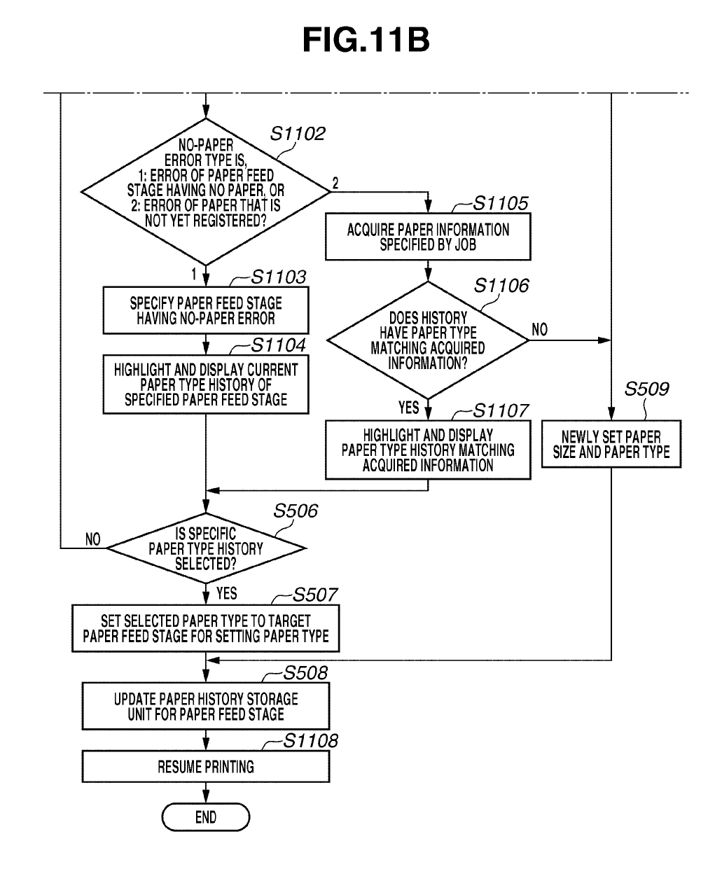

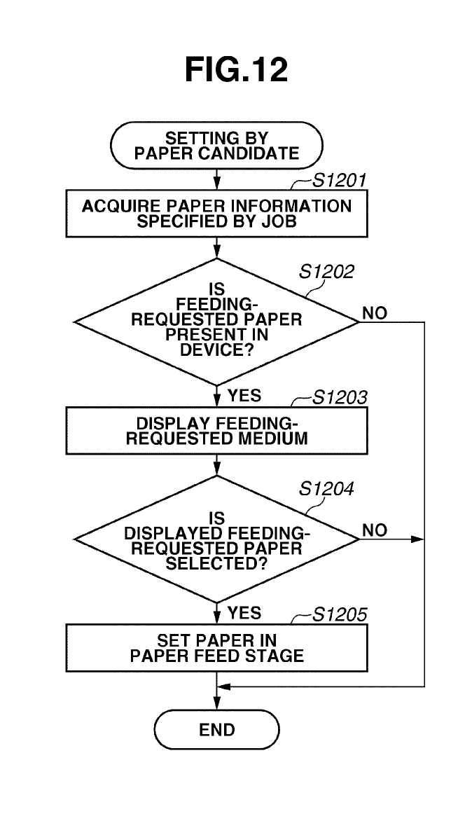

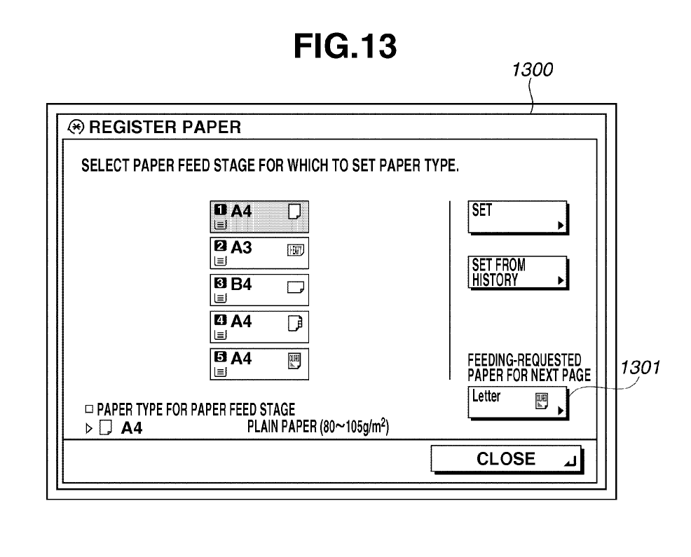

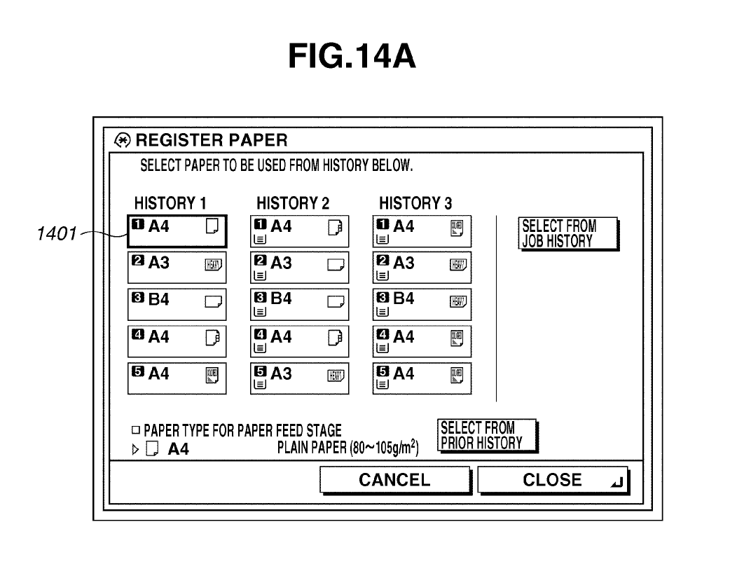

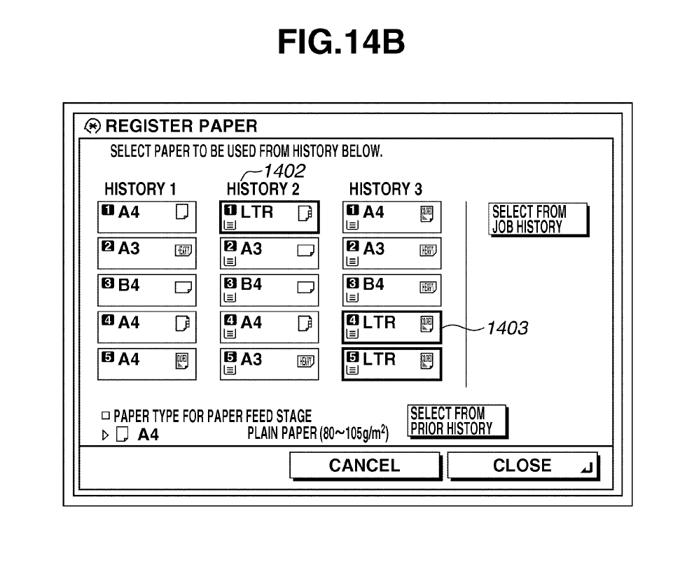

According to a second exemplary embodiment of the present invention, processing will be described that is performed when a no-paper error occurs in the paper feed stage in the image forming apparatus 10 while the print job is performed and then the paper type is set for the paper feed stage having the error, with reference to the flowcharts illustrated in FIGS. 11 and 12 and examples of display screens illustrated in FIGS. 13, 14A, and 14B.

Since the image forming system adopted to the present exemplary embodiment is the same as that adopted in the first exemplary embodiment, descriptions will not be repeated. The same numeral references are applied to the same steps to those in the first exemplary embodiment described with reference to FIG. 5, and the descriptions will not be repeated. The different steps will be mainly described below.

FIG. 11, composed of FIGS. 11A and 11B, is a flowchart illustrating, when a no-paper error occurs in the paper feed stage in the image forming apparatus 10, the processing for setting the paper type for the paper feed stage (paper feed stage having the error) in which the no-paper error has occurred. Each processing illustrated in the flowchart in FIG. 11 is performed by the control unit 201, display control unit 203, and the paper feed stage setting unit 205 when the control unit 201 executes the programs stored in the memory 202.

In step S1101, the control unit 201 monitors an event of the no-paper error to be notified from the printing unit 209. When the printing unit 209 informs the control unit 201 of the event of the no-paper error (YES in step S1101), the processing proceeds to step S506. The event of the no-paper error is notified to the control unit 201 from the printing unit 209 when the no-paper error has occurred in the paper feed stage in the image forming apparatus 10.

After steps S501, S502, S503, and S504 are performed, in step S1102, the paper feed stage setting unit 205 determines a type of the no-paper error from the notified event of the no-paper error received from the printing unit 209. When it is determined that the type of the no-paper error is the paper-out error of the paper feed stage, the processing proceeds to step S1103. On the other hand, when it is determined that the type of the no-paper error is the error of the paper that is not yet registered, the processing proceeds to step S1105.

The paper-out error of the paper feed stage is caused by a state where all paper in the paper feed stage is used up and no paper is left therein. Meanwhile, the error of the paper that is not yet registered is caused by a state where the paper type necessary for printing the next page in the print job being performed has not been set for any of the paper feed stages in the image forming apparatus 10.

In step S1103, the paper feed stage setting unit 205 acquires information about the paper feed stage having the error from the control unit 201 to specify the paper feed stage having the error from among a plurality of paper feed stages. In step S1104, the paper feed stage setting unit 205 detects the paper type history information about the paper feed stage having the error specified in step S1103 from the paper feed stage setting history storage unit 211.

The paper feed stage setting unit 205 controls the operation unit 204 to display the history setting screen in a state where the paper type history (history 1) of the paper type currently set for the paper feed stage having the error is highlighted based on the detected information.

According to the present exemplary embodiment, it is supposed that the setting of the paper type for the paper feed stage having the error is not canceled due to the no-paper error. However, the present invention can be also applied to a case where the setting thereof is canceled. For example, in the image forming apparatus 10, in a case where, when the no-paper error occurs, the paper type set for the paper feed stage having the error is canceled, in step S1104, the processing described below will be performed.

More specifically, the paper feed stage setting unit 205 controls the operation unit 204 to display the history setting screen in a state where the paper type history of the paper type set before the setting for the paper feed stage having the error is cancelled due to the error is highlighted.

As described above, in any configurations, when the type of the error is the paper-out error of the paper feed stage, the newest paper type history for the paper feed stage having the error is highlighted. The paper-out error of the paper feed stage often occurs when the paper has been used up and run out during printing. In such a case, the user mostly wants to re-set the same paper type as that of the paper that has run out. Thus, the newest paper type history for the paper feed stage having the error is highlighted so that the user can easily recognize what type of the paper has run out.

According to the present exemplary embodiment, the newest paper type history of the paper type having a higher priority for the paper feed stage having the error is highlighted. However, the method is not limited thereto. The history setting screen may be displayed in a state where the user can discriminate the newest paper type history for the paper feed stage having the error from the paper type history different from the newest paper type history for the paper feed stage having the error. For example, the history setting screen may be displayed in a state where the paper type history different from the newest paper type history of the paper type having a lower priority for the paper feed stage having the error is displayed in gray not to be able to be selected.

In step S1105, the paper feed stage setting unit 205 acquires information about the paper type necessary for printing the next page that is specified in the print job performed when the no-paper error has occurred. In step S1106, the paper feed stage setting unit 205 determines whether the paper type history matching the paper type necessary for printing the next page is included in the paper feed stage setting history storage unit 211.

When it is determined that the paper type history matching the paper type necessary for printing the next page is included in the paper feed stage setting history storage unit 211 (YES in step S1106), the processing proceeds to step S1107. On the other hand, when it is determined that the paper type history matching the paper type necessary for printing the next page is not included in the paper feed stage setting history storage unit 211, the processing proceeds to step S509.

In step S1107, the paper feed stage setting unit 205 controls the operation unit 204 to display the history setting screen in a state where, of the paper type histories for respective paper feed stages, the paper type history of the paper type specified for the next page in the print job is highlighted. The error of the paper that is not yet registered occurs since the paper type necessary for printing the next page in the print job is not set yet. Thus, the user needs to set the paper type necessary for printing the next page for the paper feed stage.

In step S1107, the paper type history of the paper type necessary for printing the next page is highlighted so that the user can recognize the paper having the paper type to be set. According to the present exemplary embodiment, the paper type history of the paper type that has a higher priority and is specified for the next page in the print job is highlighted. However, the method is not limited thereto.

The history setting screen may be displayed in a state where the user can discriminate the paper type history of the paper type specified for the next page from the paper type history different from the paper type history of the paper type specified for the next page. For example, the history setting screen may be displayed in a state where the paper type history different from the paper type history of the paper type that has a lower priority and is specified for the next page is displayed in gray not to be able to be selected.

In step S1108, the printing unit 209 resumes the print job.

According to the present exemplary embodiment, according to the type of the no-paper error that has occurred, display contents in the history setting screen are changed. However, for any type of the no-paper error, the paper type specified for the next page in the print job may be set for the paper feed stage. This configuration will be described below with reference to FIG. 12.

FIG. 12 is a flowchart illustrating processing performed after the key of the target paper feed stage for which the paper type is set is pressed in step S502 illustrated in FIG. 11.

In step S1201, the paper feed stage setting unit 205 acquires paper information specified for the next page in the print job. In step S1202, the paper feed stage setting unit 205 determines whether the paper type acquired in step S1201 is registered with the storage unit 210. When it is determined that the paper type acquired in step S1201 is registered with the storage unit 210 (YES in step S1202), the processing proceeds to step S1203. On the other hand, when it is determined that the paper type acquired in step S1201 is not registered with the storage unit 210 (NO in step S1202), the processing ends.

In step S1203, the paper feed stage setting unit 205 controls the display control unit 203 to display a paper feed stage selection screen 1300 (FIG. 13) in a state where the user can select the paper type acquired in step S1201. In step S1204, the control unit 201 monitors whether the paper type displayed in the step S1203 is pressed. When it is determined that the displayed paper-feed requested paper is pressed to be selected to be set for the target paper feed stage (YES in step S1204), the processing proceeds to step S1205.

When it is determined that the displayed paper-feed requested paper is not selected (NO in step S1204), the processing ends. In step S1205, the paper feed stage setting unit 205 sets the paper type selected in step S1204 for the paper feed stage selected in step S602. By performing the processing described above, the user can set the paper type specified for the next page in the print job with less operations.

FIG. 13 illustrates an example of the paper feed stage selection screen according to the second exemplary embodiment. Since the paper feed stage selection screen 1300 illustrated in FIG. 13 is mostly the same as the paper feed stage selection screen 800 illustrated in FIG. 8, only different parts will be described below.

A paper-feed requested paper setting key 1301 for the next page displayed in the paper feed stage selection screen 1300 detects the paper type specified for the next page from the job and displays the paper type. When the paper requested by the job is registered with the storage unit 210 in the image forming apparatus 10, the paper-feed requested paper setting key 1301 becomes valid. Thus, if the no-paper error occurs, when the user presses the paper-feed requested paper setting key 1301, the setting can be performed with one click. However, if the paper type requested for the next page is not registered with the image forming apparatus 10, the paper-feed requested paper setting key 1301 is not displayed.

FIGS. 14A and 14B illustrate examples in which the paper type histories that are highlighted in the history setting screen are switched according to the type of the no-paper error. FIG. 14A illustrates an example displayed when all paper that has been used in the paper feed stage having the error (paper feed stage 1) has run out and the paper-out error occurs. In this example, since the type of the no-paper error is the paper-out error of the paper feed stage, a paper type history 1401 that is the newest paper type history for the paper feed stage having the error (paper feed stage 1) is highlighted.

On the other hand, FIG. 14B illustrates an example displayed when the no-paper error caused by the paper type that is necessary for printing the next page in the print job being performed and is not set for any paper feed stage in the image forming apparatus 10 occurs. In this example, when the next print page is specified as AnyMedia having a letter (LTR) size and, of the paper type histories, only the paper type histories 1402 and 1403 having the LTR size are highlighted.

In the example of FIG. 14B, since the paper type adopts AnyMedia, the paper type history of any type of paper such as plain paper and colored paper is highlighted. However, when the paper requested in the print job is LTR and also the paper type is specified as the colored paper not AnyMedia, only the paper type history 1403 is highlighted.

As described above, according to the type of the no-paper error, the paper to be highlighted in the paper feed stage history is switched so that the user can easily select the paper which the user is highly likely to set. Thus, all processing to be performed when the no-paper error has occurred, when the paper is set, and when printing is resumed can be decreased.

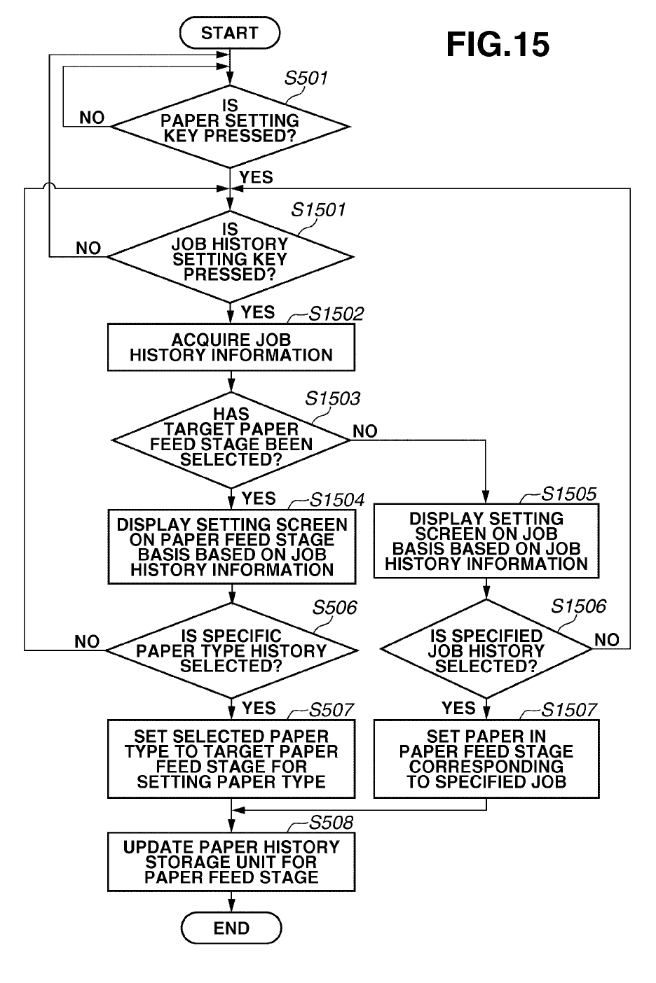

According to the first and second exemplary embodiments described above, examples are described in which the paper type setting is performed for one target paper feed stage selected in the paper feed stage selection screen. According to a third exemplary embodiment of the present invention, using the job history that is the paper type history information about a plurality of paper feed stages used in the same job, the paper type setting is performed for a plurality of paper feed stages at a time will be described with reference to FIGS. 15, 16, 17A, and 17B. Since the image forming system adopted for the present exemplary embodiment is the same as that of the first exemplary embodiment, the description will not be repeated.

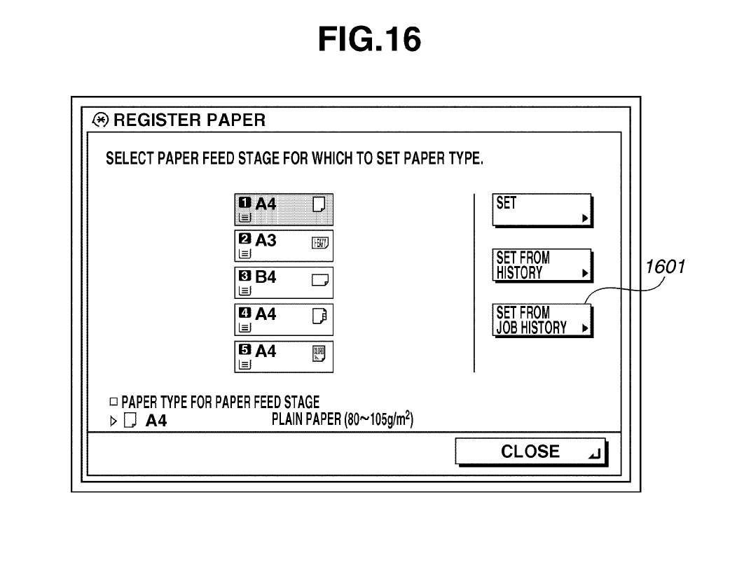

In the flowchart illustrated in FIG. 15, the same numeral references will be applied to the same steps as those described in the first exemplary embodiment with reference to FIG. 5, and different steps will be mainly described. Further, according to the present exemplary embodiment, a screen illustrated in FIG. 16 is displayed as a paper feed stage selection screen. A difference between the paper feed stage selection screen illustrated in FIG. 16 and that illustrated in FIG. 8 is a job history setting key 1601.

FIG. 15 is a flowchart illustrating processing for setting the paper type using the job history. Each processing described in the flowchart of FIG. 15 is performed by the control unit 201, the display control unit 203, and the paper feed stage setting unit 205 when the control unit 201 executes the programs stored in the memory 202.

In step S1501, the control unit 201 monitors whether the user presses the job history setting key 1601 in the paper feed stage selection screen illustrated in FIG. 16. When one of a plurality of paper feed stage key are pressed, the processing proceeds to step S1502. In this paper feed stage selection screen, the user can also select the target paper feed stage.

In step S1502, the paper feed stage setting unit 205 acquires the job history information from the paper feed stage setting history storage unit 211 and also transmits the acquired job history information to the display control unit 203. The job history information refers to the paper type history information associated with the performed print job. For example, the job history information refers to information about the setting of, when the print job “A” is performed, “A4 PLAIN PAPER” for the paper feed stage 1, “A3 HEAVY PAPER” for the paper feed stage 2, and “B4 PLAIN PAPER” for the paper feed stage 3.

In step S1503, in the paper feed stage selection screen illustrated in FIG. 16, the control unit 201 determines whether the target paper feed stage that is to be the target for setting the paper type is determined. When it is determined that the target paper feed stage is determined (YES in step S1503), the processing proceeds to step S1504. When it is determined that the target paper feed stage is not determined (NO in step S1503), the processing proceeds to step S1505.

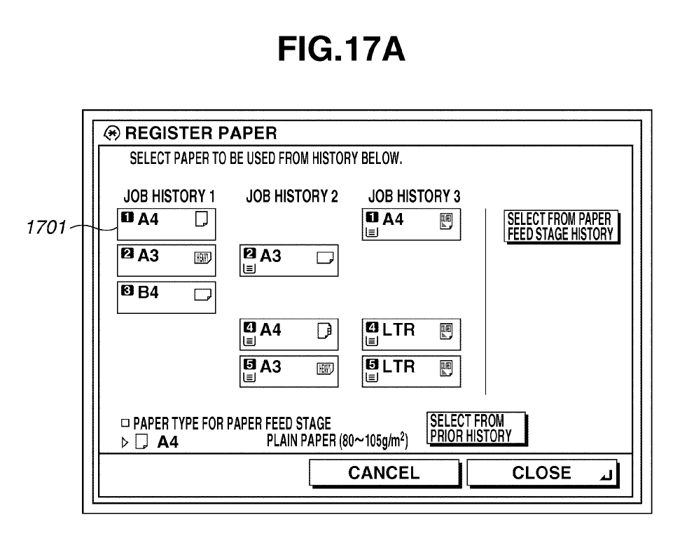

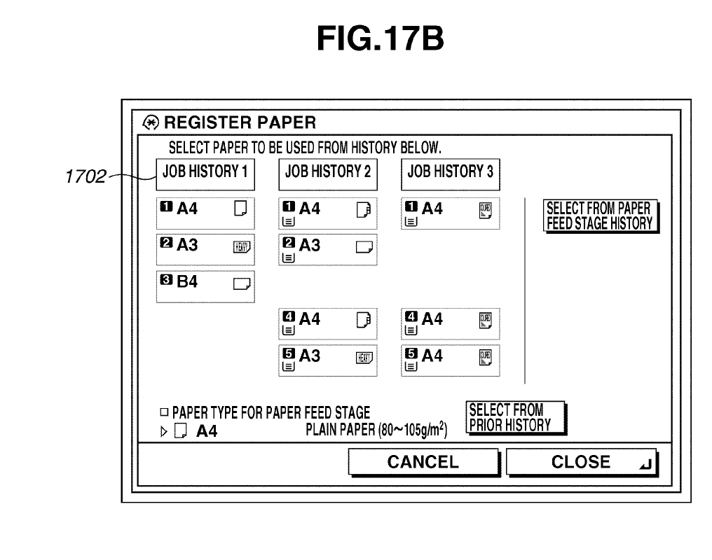

In step S1504, the display control unit 203 displays the history setting screen on a paper feed stage basis based on the job history information transmitted from the paper feed stage setting unit 205. FIG. 17A illustrates an example of the history setting screen displayed in step S1504. In the history setting screen illustrated in FIG. 17A, the paper type history (e.g., 1701) set for each paper feed stage is displayed for each past print job (job histories 1, 2, and 3) to be able to be selected.

When the user selects any one of the paper type histories that can be selected, the paper feed stage setting unit 205 sets the selected paper type for the target paper feed stage. According to the present exemplary embodiment, the job history is displayed for any paper feed stage. However, for example, when the paper feed stage 1 is the target paper feed stage, only the job history using the paper feed stage 1 may be displayed.

In step S1505, the display control unit 203 displays the history setting screen on a job basis based on the job history information transmitted from the paper feed stage setting unit 205. FIG. 17B illustrates an example of the history setting screen to be displayed in step S1505. In the history setting screen illustrated in FIG. 17B, for respective past print jobs (job histories 1, 2, and 3), the paper type history set for each paper feed stage is displayed, and then each job history is displayed to be able to be set.

When the same paper feed stage is used for another paper type a plurality of times, the paper used for the first time is displayed. Further, when the paper feed stage used for the job history is not present, the paper type in the paper feed stage is not displayed.

In step S1506, the control unit 201 waits until the user selects the specific job history from a plurality of job histories via the history setting screen displayed in step S1505 and then gives an instruction for setting the paper type on a job basis. When the user selects the specific job history and gives the instruction for setting the paper type (YES in step S1506), the processing proceeds to step S1507. On the other hand, when the user does not select the specific paper type history and presses the cancel key (NO in step S1506), the processing returns to step S1501.

In step S1507, the paper feed stage setting unit 205 sets the paper type matching the selected job history for each paper feed stage corresponding to the job history selected in step S1506. For example, in the history setting screen illustrated in FIG. 17B, when the job history 1 (1702) is selected, the paper feed stage setting unit 205 sets “A4 PLAIN PAPER” for the paper feed stage 1, “A3 HEAVY PAPER” for the paper feed stage 2, and “B4 PLAIN PAPER” for the paper feed stage 3, respectively.

According to the present exemplary embodiment, the paper type selection can be performed based on the job history information so that the user can easily determine what paper type is to be set for what paper feed stage. Further, the displays and the selection methods are switched according to whether the target paper feed stage has been determined, thereby improving convenience for users. Furthermore, a plurality of paper types that have been used before can be collectively set for each job into a plurality of paper feed stages, thereby improving operational efficiency.

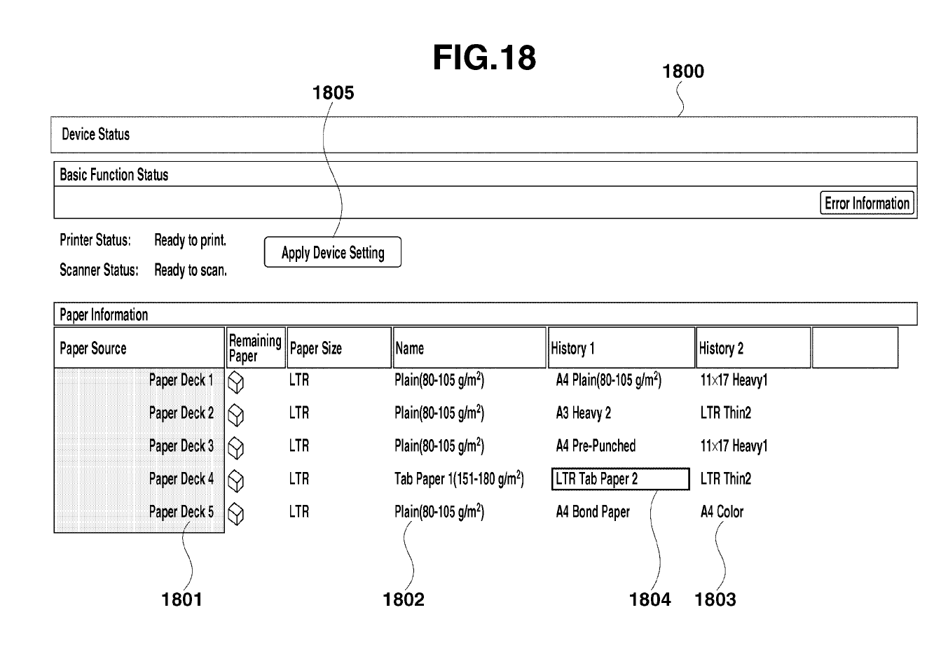

According to a fourth exemplary embodiment of the present invention illustrated in FIG. 18, setting of the paper feed stage history, which is displayed on the touch panel portion 2041 described in the first, second, and third exemplary embodiments, is displayed on a remote user interface (UI). The setting and control of the paper feed stage are the same as those of the flowchart illustrated in FIG. 5.

The user can access the remote UI 1800 from a client personal computer (PC) 40 via the external interface 207 to browse and edit the setting of the image forming apparatus 10.

A paper feed stage display portion 1801 displays the paper feed stage connected to the image forming apparatus 10. A setting paper type display portion 1802 displays the paper type information set for the paper feed stage. A history display portion 1803 displays the history information for each paper feed stage. A paper selection display portion 1804 selects and displays the paper type to be set for the paper feed stage from the history display. A setting application portion 1805 transmits contents set via the remote UI 1800 to the external interface 207.

The user can perform the setting from the history for each paper feed stage via the remote UI 1800 as well as the touch panel portion 2041, thereby improving operability when the user registers the paper. Further, if the information stored in the paper feed stage setting history storage unit 211 and the job history storage unit 212 included in the image forming apparatus 10 can be exported or imported via the remote UI 1800, the paper feed stage history information used by another image forming apparatus can be used.

The present invention can be also realized by performing the processing described below. More specifically, software (program) for realizing the aforementioned functions of the exemplary embodiments is supplied to the system or the apparatus via the network or various types of storage media, and then a computer (central processing unit (CPU) or micro processing unit (MPU)) of the system or the apparatus reads the programs to perform the processing. In this case, the programs and the storage media storing the programs constitute the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-278010 filed Dec. 7, 2009, which is hereby incorporated by reference herein in its entirety.

What is claimed is:

1. An image forming apparatus including a plurality of paper feed stages, the image forming apparatus comprising:
a setting unit configured to set a paper type including a plurality of items for each of the plurality of paper feed stages;
a storage unit configured to store a paper type history indicating a history of one or more paper types set by the setting unit for each paper feed stage;
an acquisition unit configured to acquire the paper type history for each paper feed stage stored by the storage unit; and
a display control unit configured to display the paper type history for each paper feed stage acquired by the acquisition unit in a setting screen on a display unit for setting the paper type for one of the plurality of paper feed stages to be able to be selected,
wherein the setting unit sets, for the one paper feed stage, the paper type selected from the paper type history for each paper feed stage via the setting screen displayed by the display control unit.

2. The image forming apparatus according to claim 1, wherein the display control unit displays the setting screen on the display unit in a state where, of paper type histories for the respective paper feed stages, a history of a paper type capable of being set for the one paper feed stage is able to be discriminated from a history of a paper type not capable of being set therefor.

3. The image forming apparatus according to claim 1, wherein the display control unit changes, according to a type of a no-paper error occurring in the one paper feed stage, contents to be displayed on the display unit.

4. The image forming apparatus according to claim 3, wherein, when the no-paper error occurring in the one paper feed stage is caused by a state where no paper is left in the paper feed stage, the display control unit displays the setting screen on the display unit in a state where, of paper type histories for the respective paper feed stages, a paper type history of a paper type currently set for the paper feed stage is able to be discriminated from a paper type history of the paper type different from the paper type currently set for the paper feed stage.

5. The image forming apparatus according to claim 3, wherein, when the no-paper error occurring in the one paper feed stage is caused by a paper type that is necessary for printing a next page and not set for the paper feed stage, the display control unit displays the setting screen on the display unit in a state where, of paper type histories for the respective paper feed stages, a paper type history of a paper type specified for the next page is able to be discriminated from another paper type history.

6. The image forming apparatus according to claim 2, wherein, of paper type histories for the respective paper feed stages, the display control unit highlights a paper type history having a high priority to enable the paper type history to be discriminated from another paper type history.

7. The image forming apparatus according to claim 2, wherein, of paper type histories for the respective paper feed stages, the display control unit displays a paper type history having a low priority in gray to enable the paper type history to be discriminated from another paper type history.

8. The image forming apparatus according to claim 1, wherein the storage unit stores job history information indicating a history of one or more jobs in which the paper type set by the setting unit is used in association with the paper type history of the paper type;
wherein the display control unit displays, based on the job history information, on the display unit, a setting screen in which paper type histories for a plurality of paper feed stages used in a same job are able to be selected on a job basis; and
wherein the setting unit sets a paper type based on a paper type history on a job basis selected via the setting screen for each of the plurality of paper feed stages.

9. The image forming apparatus according to claim 8, further comprising a determination unit configured to determine, of the plurality of paper feed stages, a target paper feed stage for which the paper type is set,
wherein, when the target paper feed stage is determined by the determination unit, the display control unit displays a setting screen in which a paper type is able to be set on a paper feed stage basis, and, when the target paper feed stage is not determined, the display control unit displays a setting screen in which a paper type is able to be collectively set for the plurality of paper feed stages.

10. A method for controlling an image forming apparatus including a plurality of paper feed stages, the method comprising:
setting a paper type including a plurality of items for each of the plurality of paper feed stages;
storing a paper type history indicating a history of one or more paper types set for each paper feed stage in a storage unit;
acquiring the stored paper type history for each paper feed stage;
displaying the acquired paper type history for each paper feed stage in a setting screen on a display unit for setting the paper type for one of the plurality of paper feed stages to be able to be selected; and
setting, for the one paper feed stage, the paper type selected from the paper type history for each paper feed stage via the displayed setting screen.

11. The method according to claim 10, further comprising displaying the setting screen on the display unit in a state where, of paper type histories for the respective paper feed stages, a history of a paper type capable of being set for the one paper feed stage is able to be discriminated from a history of a paper type not capable of being set therefor.

12. The method according to claim 10, further comprising changing, according to a type of a no-paper error of the one paper feed stage, contents to be displayed on the display unit.

13. The method according to claim 12, further comprising, when the no-paper error occurring in the one paper feed stage is caused by a state where no paper is left in the paper feed stage, displaying the setting screen on the display unit in a state where, of paper type histories for the respective paper feed stages, a paper type history of a paper type currently set for the paper feed stage is able to be discriminated from a paper type history of the paper type different from the paper type currently set for the paper feed stage.

14. The method according to claim 12, further comprising, when the no-paper error occurring in the one paper feed stage is caused by a paper type that is necessary for printing a next page and not set for the paper feed stage, displaying the setting screen on the display unit in a state where, of paper type histories for the respective paper feed stages, a paper type history of a paper type specified for the next page is able to be discriminated from another paper type history.

15. The method according to claim 11, further comprising highlighting, of paper type histories for the respective paper feed stages, a paper type history having a high priority to enable the paper type history to be discriminated from another paper type history.

16. The method according to claim 11, further comprising displaying, of paper type histories for the respective paper feed stages, a paper type history having a low priority in gray to enable the paper type history to be discriminated from another paper type history.

17. The method according to claim 10, further comprising:
storing, in the storage unit, job history information indicating a history of one or more jobs in which the set paper type is used in association with the paper type history of the paper type;
displaying, based on the job history information, a setting screen on the display unit in a state where paper type histories for a plurality of paper feed stages used in a same job are able to be selected on a job bases; and
setting a paper type based on a paper type history on a job bases selected via the setting screen for each of the plurality of paper feed stages.

18. The method according to claim 17, further comprising:
determining, of the plurality of paper feed stages, a target paper feed stage for which the paper type is set; and
displaying, when the target paper feed stage is determined, a setting screen in which a paper type is able to be set on a paper feed stage basis, and, displaying, when the target paper feed stage is not determined, a setting screen in which a paper type is able to be collectively set for the plurality of paper feed stages on a job basis.

19. A computer-readable storage medium storing a program for causing a computer to execute the method according to claim 10.
